(19) United States
(12) Patent Application Publication
(10) Pub. No.: US 2009/0010277 A1
(43) Pub. Date: Jan. 8, 2009

(54) METHOD AND SYSTEM FOR SELECTING A RECORDING ROUTE IN A MULTI-MEDIA RECORDING ENVIRONMENT

(76) Inventors: Eran Halbraich, Bet Zayit (IL); Yariv Lenchner, Petach Tikva (IL); Leonid Portman, Rishon Lezion (IL); Stas Margolis, Alfel Menashe (IL); Ilan Yosef, Pardessiya (IL)

Correspondence Address: Pearl Cohen Zedek Latzer, LLP, 1500 Broadway, 12th Floor, New York, NY, 10036, US

(21) Appl. No.: 11/772,852

(22) Filed: Jul. 3, 2007

(51) Int. Cl. H04J 3/22

(52) U.S. Cl. 370/465

(57) ABSTRACT

Device and method for receiving information from one or more media providers capable of transmitting a media session and from one or more media recorders capable of recording the media session and selecting one of the recorders for recording the media session based on the received information and a predetermined set of rules.

### BACKGROUND

Capturing and recording multimedia data is a frequent and well known practice within commercial environments, as well as among private individuals. For example, many industries rely on call centers for the collection and management of critical customer information. As the volumes of communication sessions grow, and customer data collection and customer inquiries become more complex, there is a need for efficiency and flexibility in communication recordings systems.

Current telecommunications systems offers sending multimedia data of a communication session from media providers to predetermined recording and monitoring systems without taking into consideration information and parameters of the media providers, the multimedia data or the recording systems. The need for a mechanism for selecting the proper recording system for each media session based on dynamic analysis of information received from media providers and recording systems is highly required.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high-level block diagram of an exemplary telecommunication recording environment according to embodiments of the present invention; and

FIG. 2 is a flowchart of a method for selecting a recording route in a multi-media recording environment according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF DEMONSTRATIVE EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

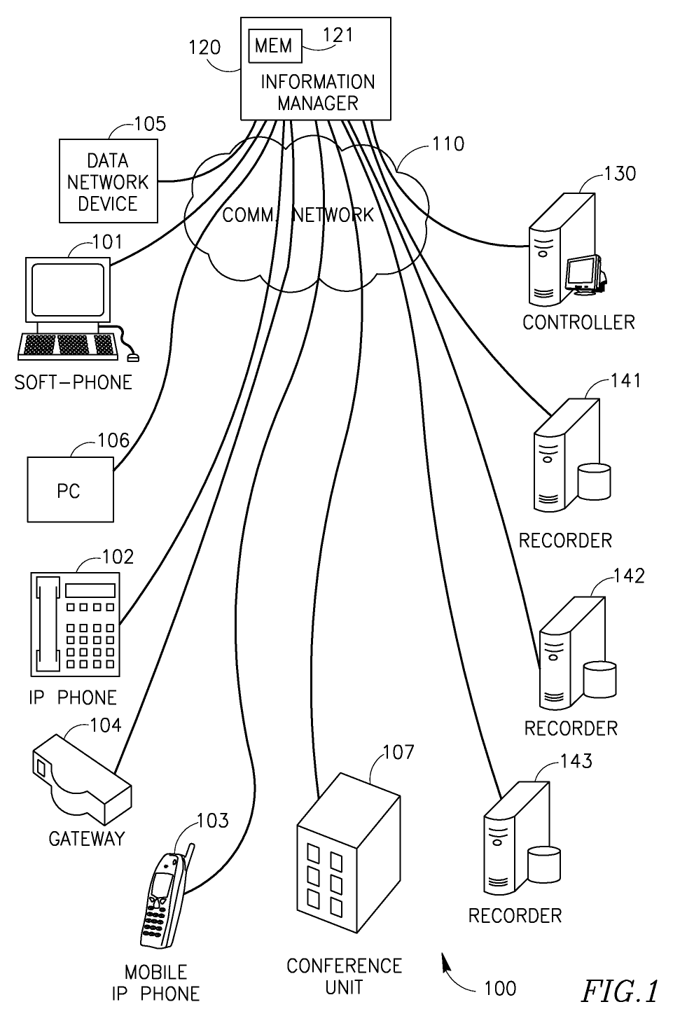

Reference is now made to FIG. 1, which is a high-level block diagram of an exemplary telecommunication recording environment according to embodiments of the present invention. A telecommunication environment 100 may include one or more media providers or entities, for example, a soft Internet Protocol (IP) telephone 101, a hard IP phone 102, a mobile IP phone 103, a gateway 104, a personal computer (PC) 106, a data network device 105 and a conference unit 107, all capable of initiating and sending communication sessions via a wired or wireless communications network 110 to one or more recording systems, for example, recorders 141, 142 and 143. Non exhaustive list of data network devices may include a switch, a router and session border controller.

Although in the exemplary illustration of FIG. 1, seven media providers and three recorders are shown, it should be understood to a person skilled in art that the invention is not limited in this respect and according to embodiments of the present invention, telecommunication recording environment 100 may include any suitable numbers of media providers and recording systems and any other type of media providers and recording systems.

Throughout the specification and claims a media provider may refer to any kind of telecommunication entity which may be capable of sending multimedia data to a monitoring and/or recording system. A communication session may refer to any audio data, video data, screen capture data or any other media or multi-media session.

Recording environment 100 may include an information manager 120 which may be connected to a controller 130 and may collect information from media providers 101-107 and recorders 141-143 in order to optimize the recording process by performing a selective decision regarding which recorder may record each session based on information from the media providers and/or recorders as is described in detail below.

Although in the exemplary illustration of FIG. 1, information manager 120 and controller 130 are stand alone units, it should be understood to a person skilled in art that the invention is not limited in this respect and according to embodiments of the present invention information manager 120 and controller 130 may be embedded in the same housing.

Communications network 110 may include any wireless or wired network communication network such as, a Local Area Network (LAN), a Wireless LAN (WLAN), a Metropolitan Area Network (MAN), a Wireless MAN (WMAN), a Wide Area Network (WAN), a Wireless WAN (WWAN) and networks operating in accordance with existing IEEE 802.11, 802.11a, 802.11b, 802.11e, 802.11g, 802.11h, 802.11i, 802.11n, 802.16, 802.16d, 802.16e standards and/or future versions and/or derivatives and/or Long Term Evolution (LTE) of the above standards. Although in the exemplary illustration of FIG. 1, a single communication network is shown, it should be understood to a person skilled in art that the invention is not limited in this respect and that according to embodiments of the present invention, telecommunication recording environment 100 may include any suitable numbers or combinations of communication networks.

According to some embodiments of the invention, a communications network, for example, network 110 within recording environment 100 may allow sending replicated multimedia data of a communication session initiated by one of media providers 101-107 to a recording and/or monitoring system, for example, one of recorders 141-143. Sending replicated multimedia data may be performed by forking and forwarding the media packets. Media providers that may perform the forking may include telephones, such as IP telephone 102, mobile IP telephone 103 and IP soft telephone 101. Other media providers which may perform the forking may include PC applications 106 or software modules running on computers with access to the multimedia data, conference units 107, media gateways 104, data network devices, such as switches, routers, session boarder controllers, dedicated recording gateways or any media proxy devices.

Recording environment 100 may be a complex environment, e.g., it may include a large number of media providers and recording systems. The efficiency of the entire recording environment 100 may improve by analyzing information and parameters received from media providers and recording systems to select for a particular recording session a particular recording system and in some cases a particular media provider based on a predetermined set of rules. The rules may be static rules or dynamic rules.

Non limiting examples of static rules, may include, for example, a load balancing rule, such as selecting the least loaded recorder, a business rule such as directing all recordings from a specific media provider or group of media providers to a specific recorder, a bandwidth-saving rule, such as selecting a media provider with the most available bandwidth, a business cost-saving rule, such as selecting a media provider with the lowest cost of forking the media.

Non limiting examples of dynamic rules may include proximity rules, such as selecting a media provider and a recorder according to their geographical proximity and quality-of-service rules. For example, mobile media providers may roam from place to place and may change their location and/or other network related parameters during a single session. Accordingly, the recording of remaining of the session may be performed by another recording system that is more suitable to the new conditions based on a predefined quality-of-service policy.

According to embodiments of the invention, the efficiency of recording environment 100 may improve by being flexible, for example, by making decisions based on information analysis or by matching between a media provider and a recorder based on dynamically changed information of the media providers and recorders.

Some of the rules may assume that more than one media provider has access to the requested media. For example, some media providers may allow the use of a sniffing mechanism based on mirroring network traffic or on network tapping devices. Access to the network traffic or media data may be available at one or more points in recording environment 100 and therefore more than one media provider may provide the same media data, for example, using the sniffing mechanism.

According to some embodiments of the invention, media providers 101-107 may transmit, transfer or send information to information manager 120. The information reported to information manager 120 may include, for example, information regarding characteristics and capabilities of media providers 101-107, information regarding the session to be recorded or any other information. Although the scope of the present invention is not limited in this respect, the information regarding the session may include, for example, indication of encryption and encryption type, the duration of the session or any other information.

Although the scope of the present invention is not limited in this respect, the information associated with the media providers may include, for example, available resources of the media provides such as available CPU resources and available hardware encryption resources, capabilities of a media provider such as media encryption capabilities, characteristics of the media provider such as geographical location, and network related properties such as bandwidth, latency, speed, packet loss and presence information. Parameters associated with presence information include device online status such as “ready”, “in error” and the like, agent status such as “in call”, “working after call”, “ready”, “away” and the like, or any other information.

Although the scope of the present invention is not limited in this respect, in some embodiments of the invention, media providers 101-107 may communicate with information manager 120 via Session Initiation Protocol (SIP), for example by utilizing the presence concept. For example, the definition of presence may be extended to include, for example, the information regarding media providers, as detailed above.

According to some embodiments of the invention, recorders 141-143 may transmit information to information manager 120. The information which may be reported to information manager 120 may include, for example, information regarding the characteristics and capabilities of recorders 141-143, or any other information. Although the scope of the present invention is not limited in this respect, the recorder's information may include, for example, characteristics of the recorder such as geographical location, network-related properties such as bandwidth, latency, speed, packet loss and presence information. Parameters associated with presence information may include available resources of the recorder such as available central processing unit (CPU) resources, available hardware encryption resources, available short term storage or any other information. Recorders 141-143 may communicate with media providers 101-107 using, for example, forwarding-based protocol over SIP as disclosed in U.S. application Ser. No. 11/503,117 to enable media forking. It should be understood to a person skilled in the art that any other protocol may be used.

Information manager 120 may be a server, e.g., a database server and may collect the information received from media providers 101-107 and recorders 141-143 and store it in a dedicated storage 121. Although the scope of the present invention is not limited in this respect, types of storage or memory that may be used with embodiments of the present invention may include, for example, a hard disk, a Flash memory, a random access memory (RAM), dynamic RAM (DRAM), static RAM (SRAM) and the like.

According to some embodiments of the present invention, information manager 120 may constantly receive information from media providers 101-107 and recorders 141-143, and may update the stored information in storage 121 based on the last information or data received. For example, mobile IP phone 103 may roam from a first location to a second location during a single session. Accordingly, information manager 120 may update the records related to the network-related parameters and location information of mobile IP device 103 and based on the new data controller 130 may decide to dynamically change the recorder during a single session.

Controller 130 may be coupled to information manager 120 and may access the information stored in storage 121 in order to dynamically analyze the information and control the recording process according to a predetermined policy, as is described in detail below. Although the scope of the present invention is not limited in this respect, controller 130 may be implemented using any suitable combination of software and/or hardware and may be implemented as a standalone unit or as a part of information manager 120.

According to some embodiments of the invention, controller 130 may use the information provided by media providers 101-107 and recorders 141-143 to perform a decision making analysis to select the best matched recorder to record a session initiated by a media provider. The preferred pair of a media provider and a recorder may be based on a predetermined policy, considerations or conditions which may be applied by controller 130 while analyzing the information stored in storage 121. For example, a set of conditions may be stored in memory 131 of controller 131 or programmed by, for example, a system administrator. The conditions may be dynamically changed according to specific requirements of recording environment 100 and the characteristics of its elements, e.g., the characteristics of media providers 101-107.

Although the scope of the present invention is not limited in this respect, a plurality of policies or conditions may be implemented by controller 130. Non-limiting examples of policies may be, for example, a bandwidth optimization policy, in which controller 130 may select a media provider capable of providing a session to be recorded in a compressed format, a quality optimization policy, in which controller 130 may select a media provider capable of providing a session to be recorded in an uncompressed format and the like.

Another policy for controller 130 may be to select pairs of media provider and recorder based on similarity in terms of network parameters, such as location. For example, a session may be provided both from a soft telephone e.g., IP soft telephone 101 and from a gateway at a call center, e.g., gateway 104. Recorder 141 may reside at the call center, therefore controller 130 may choose recorder 141 to record the session provided by gateway 104. Yet another policy for controller 130 may be to select pairs of media provider and recorder based on the proximity of the media provider and the recorder. Recording environment 100 may include a plurality of distributed physical locations, each including media providers and optionally one or more recorders. At certain scenarios, the same session may be provided by media providers at different locations. Controller 130 may then select for the recording of that session a recorder and media provider residing at the same location.

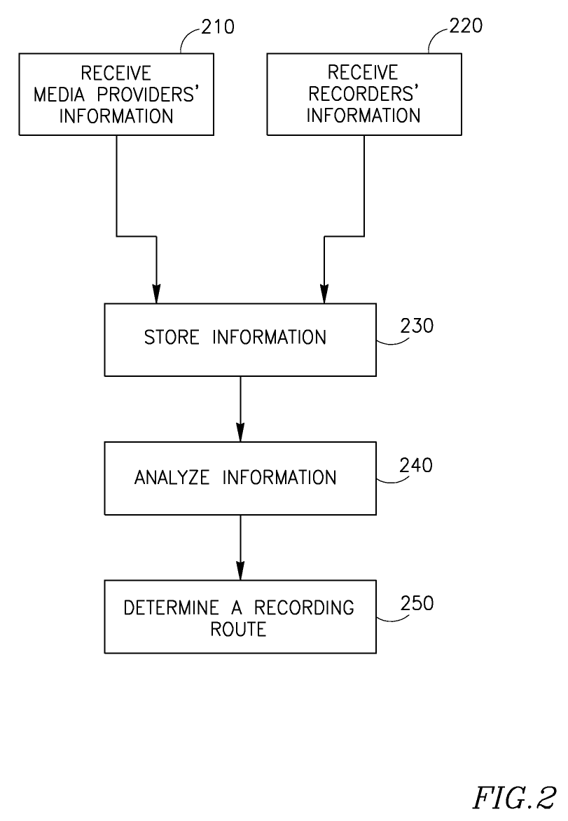

Reference is now made to FIG. 2, which is a flowchart of a method for selecting a recording route in a multi-media recording environment according to embodiments of the present invention. Operations of the method may be implemented, for example, by system 100 of FIG. 1, by any or all of media providers 101-107 and recorders 11-143 of FIG. 1, and/or by other suitable units, devices, and/or systems.

As indicated at box 210, the method may include receiving information from media providers, for example, media providers 101-107 (of FIG. 1). The information may be received anytime during the session or out of session. The information may include characteristics of the media providers such as, geographical location, network related parameters, available resources, and properties of a session initiated by a media provider, such as, session format, session duration and the like. The information may be transferred by the media provider, for example, via SIP and in the form of presence information to a dedicated server, for example, information manager 120 (of FIG. 1). Any other suitable method or protocol for transferring information may be used.

As indicated at box 220, the method may include receiving information from recorders or recording systems, for example, recorders 141-143 (of FIG. 1). The information may be received anytime during the session or out of session. The information may include properties and characteristics of the recorders such as, geographical location, network related parameters, available resources and the like. The information may be transferred by the recorders to a dedicated server, for example, information manager 120 by using for example SIP. It should be understood, however to a person skilled in the art that any other suitable method or protocol for transferring information may be used.

As indicated at box 230, the method may include storing the information received from the media providers and the recorders in a general or dedicated storage medium, for example, in a storage unit of information manager 120. The method may further include continuously updating the stored information in real time while receiving updated information from the media providers and/or the recorders. For example, a media provider may roam from one location to another location and thereby its parameters may be changed, in such an exemplary situation the media provider may transfer its new parameters and the stored information may be updated.

As indicated at box 240, the method may include dynamically analyzing the information received from media providers 101-107 and recorders 141-143 by a system manager, for example, controller 130. Analyzing the information may be performed based on pre-stored conditions or required policies in order to achieve an optimized decision regarding which recorder is to record a media session as indicated at box 250.

As indicated at box 250, the method may include determining, deciding or selecting which recorder is to record a media session (or part of a media session) based on the information analysis indicated at box 240. Additionally, the method may include determining from which media provider to send the media to the recorder. The decision or selection may be based on specific conditions or policies and may match the most efficient pairs of media provider and recorder to meet the required policies or conditions while dynamically checking the information received at boxes 210 and 220.

According to some embodiments of the present invention the features of the method which are described at boxes 230, 240 and 250 may be implemented at a single physical unit and according to other embodiments may be implemented at separate physical units. Other operations or sets of operations may be used in accordance with embodiments of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An apparatus for managing recording of media sessions, the apparatus comprising:
an information manager to receive information from one or more media providers capable of transmitting a media session over a communication network and from one or more media recorders capable of recording the media session; and
a controller coupled to the information manager to select one of the recorders for recording the media session based on the received information and a predetermined set of rules.

2. The apparatus of claim 1, wherein the controller is to select one of the media providers capable of transmitting the media session.

3. The apparatus of claim 1, wherein the controller is to analyze the received information.

4. The apparatus of claim 1, wherein the set of rules are proximity rules, quality-of-service rules, load balancing rules, business rules, bandwidth-saving rules, cost-saving rules or presence based rules.

5. The apparatus of claim 1, wherein the media providers are soft Internet protocol telephones, hard Internet protocol telephones, mobile Internet protocol telephones, gateways, personal computers, conference units or data network devices.

6. The apparatus of claim 1, wherein the information is received over session initiation protocol.

7. The apparatus of claim 1, wherein the information received from the media providers comprises characteristics of the media providers, the media session and the communication network.

8. The apparatus of claim 7, wherein the characteristics of the media providers are available central processing unit resources, available hardware encryption resources or geographical location.

9. The apparatus of claim 7, wherein the characteristics of the communication network are bandwidth, latency, speed, packet loss and presence information.

10. The apparatus of claim 1, wherein the information received from the recorders comprises characteristics of the recorders and the communication network.

11. The apparatus of claim 1 comprising:
a storage to store the information received from the media providers and the recorders.

12. A method for managing recording of media sessions comprising:
receiving information from one or more media providers capable of transmitting a media session over a communication network;
receiving information from one or more media recorders capable of recording the media session; and
selecting one of the recorders for recording the media session based on the received information and a predetermined set of rules.

13. The method of claim 12 further comprising:
selecting one of the media providers capable of transmitting the same media session.

14. The method of claim 12 further comprising:
analyzing the received information.

15. The method of claim 12, wherein the set of rules are proximity rules, quality-of-service rules, load balancing rules, business rules, bandwidth-saving rules, cost-saving rules or presence based rules.

16. The method of claim 12, wherein the media providers are soft Internet protocol telephones, hard Internet protocol telephones, mobile Internet protocol telephones, gateways, personal computers, conference units or data network devices.

17. The method of claim 12, wherein the information is received over session initiation protocol.

18. The method of claim 12, wherein the information received from the media providers comprises characteristics of the media providers, the media session and the communication network.

19. The method of claim 18, wherein the characteristics of the media providers are available central processing unit resources, available hardware encryption resources or geographical location.

20. The method of claim 18, wherein the characteristics of the communication network are bandwidth, latency, speed, packet loss and presence information.

21. The method of claim 12, wherein the information received from the recorders comprises characteristics of the recorders and the communication network.

22. A computer readable-medium, having stored thereon instructions, that when executed on a computing platform, result in:
receiving information from one or more media providers capable of transmitting a media session over a communication network;
receiving information from one or more media recorders capable of recording the media session; and
selecting one of the recorders for recording the media session based on the received information and a predetermined set of rules.

23. The medium of claim 22, wherein the instructions further comprise selecting one of the media providers capable of transmitting the same media session.

24. The medium of claim 22, wherein the instructions further comprise analyzing the received information.

25. The medium of claim 22, wherein the set of rules are proximity rules, quality-of-service rules, load balancing rules, business rules, bandwidth-saving rules, cost-saving rules or presence based rules.

26. The medium of claim 22, wherein the media providers are soft Internet protocol telephones, hard Internet protocol telephones, mobile Internet protocol telephones, gateways, personal computers, conference units or data network devices.

27. The medium of claim 22, wherein the information is received over session initiation protocol.

28. The medium of claim 22, wherein the information received from the media providers comprises characteristics of the media providers, the media session and the communication network.

29. The medium of claim 22, wherein the characteristics of the media providers are available central processing unit resources, available hardware encryption resources or geographical location.

30. The medium of claim 22, wherein the characteristics of the communication network are bandwidth, latency, speed, packet loss and presence information.

31. The medium of claim 22, wherein the information received from the recorders comprises characteristics of the recorders and the communication network.
